(19) United States
(12) Patent Application Publication
(10) Pub. No.: US 2016/0031127 A1
(43) Pub. Date: Feb. 4, 2016

(54) METHOD OF FABRICATING FLEXIBLE DISPLAY PANEL

(71) Applicant: Au Optronics Corporation, Hsinchu (TW)

(72) Inventors: Yu-Chen Chang, Kaohsiung City (TW); Chun-Hsien Chao, Kaohsiung City (TW); Kai-Chieh Wu, Taipei City (TW); Chien-Ying Chen, Kaohsiung City (TW); Yu-Hsin Lin, Taoyuan County (TW)

(21) Appl. No.: 14/817,214

(22) Filed: Aug. 4, 2015

(30) Foreign Application Priority Data
Aug. 4, 2014 (TW) 103126619

(51) Int. Cl. B29C 41/42; B29C 41/00

(52) U.S. Cl. CPC B29C 41/42; B29C 41/003; B29K 2079/085

(57) ABSTRACT

A method of fabricating a flexible display panel is provided. In the method, a rigid substrate is provided, a fluorinated polyimide substrate is formed on the rigid substrate, a display device is formed on the fluorinated polyimide substrate, and the fluorinated polyimide substrate is separated from the rigid substrate.

### CROSS-REFERENCE TO RELATED APPLICATION

This application claims the priority benefit of Taiwan application serial no. 103126619, filed on Aug. 4, 2014. The entirety of the above-mentioned patent application is hereby incorporated by reference herein and made a part of this specification.

### FIELD OF THE INVENTION

The invention relates to a method of fabricating a display panel. More particularly, the invention relates to a method of manufacturing a flexible display panel.

### DESCRIPTION OF RELATED ART

According to the existing display technology, the flexible display panel characterized by light weight, great impact endurance, flexibility, wearability, and portability has become one of the leading display panels at present. In the contemporary technology of forming the flexible display panel, a releasing layer is often required to be formed between a flexible substrate and a supportive rigid substrate, so as to separate the flexible substrate from the rigid substrate. Nevertheless, the formation of the releasing layer for separating the flexible substrate from the rigid substrate not only adds an evaporation step to the process of manufacturing the flexible display panel and thereby raises the manufacturing costs but also leads to decomposition and out-gassing effects on the releasing layer because the releasing layer cannot bear the high temperature in the existing process of manufacturing a thin film transistor array. Thereby, the flexible substrate is very much likely to face the issue of warping. Accordingly, how to manufacture the flexible display panel without forming any releasing layer has become one of the main issues to be resolved.

### SUMMARY OF THE INVENTION

The invention is directed to a method of manufacturing a flexible display panel by which the flexible display panel can be manufactured without forming any releasing layer.

In an embodiment of the invention, a method of fabricating a flexible display panel is provided. In the method, a rigid substrate is provided, a fluorinated polyimide substrate is formed on the rigid substrate, a display device is formed on the fluorinated polyimide substrate, and the fluorinated polyimide substrate is separated from the rigid substrate.

According to an embodiment of the invention, when the display device is formed on the fluorinated polyimide substrate, a manufacturing temperature is from 200° C. to 450° C., and a peeling force between the fluorinated polyimide substrate and the rigid substrate is 50 gf to 500 gf.

According to an embodiment of the invention, when the fluorinated polyimide substrate is separated from the rigid substrate, a manufacturing temperature is from 25° C. to 30° C., and a peeling force between the fluorinated polyimide substrate and the rigid substrate is 3 gf to 12 gf.

According to an embodiment of the invention, a method of separating the fluorinated polyimide substrate from the rigid substrate includes mechanical debonding, laser lift-off, and temporary adhesion debonding.

According to an embodiment of the invention, after the fluorinated polyimide substrate is separated from the rigid substrate, the method further includes adhering a back plate onto the fluorinated polyimide substrate, and the back plate and the display device are respectively located on two opposite surfaces of the fluorinated polyimide substrate.

According to an embodiment of the invention, the rigid substrate includes a glass substrate.

According to an embodiment of the invention, an amount of fluorine in the fluorinated polyimide substrate is from 5 wt % to 35 wt %.

According to an embodiment of the invention, the display device includes a liquid crystal display panel, an electrowetting display device, or an organic light emitting diode (LED) display device.

According to an embodiment of the invention, when the fluorinated polyimide substrate is formed on the rigid substrate, the fluorinated polyimide substrate is in direct contact with the rigid substrate.

In view of the above, according to the method of fabricating the flexible display panel provided herein, the fluorinated polyimide substrate is directly formed on the rigid substrate, so as to manufacture the flexible display panel without forming any releasing layer.

Several exemplary embodiments accompanied with figures are described in detail below to further describe the invention in details.

### BRIEF DESCRIPTION OF THE DRAWINGS

FIG. 1 is a flowchart of a method of fabricating a flexible display panel according to an embodiment of the invention.

FIG. 2A to FIG. 2E are schematic cross-sectional diagrams illustrating a method of fabricating a flexible display panel according to an embodiment of the invention.

FIG. 3 illustrates the correlation between a peeling force between a fluorinated polyimide substrate and a glass substrate and an amount of fluorine in the fluorinated polyimide substrate.

FIG. 4 illustrates the correlation between temperature and a peeling force between a fluorinated polyimide substrate and a glass substrate.

### DETAILED DESCRIPTION OF DISCLOSED EMBODIMENTS

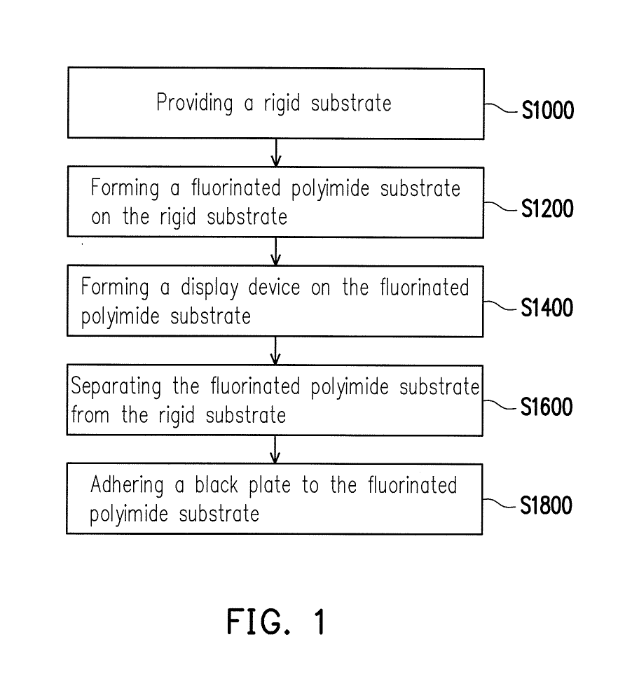

FIG. 1 is a flowchart of a method of fabricating a flexible display panel according to an embodiment of the invention. With reference to FIG. 1, a method of fabricating a flexible display panel provided in the present embodiment includes: providing a rigid substrate (step S1000), forming a fluorinated polyimide substrate on the rigid substrate (step S1200), forming a display device on the fluorinated polyimide substrate (step S1400), separating the fluorinated polyimide substrate from the rigid substrate (step S1600), and adhering a back plate onto the fluorinated polyimide substrate (step S1800 ).

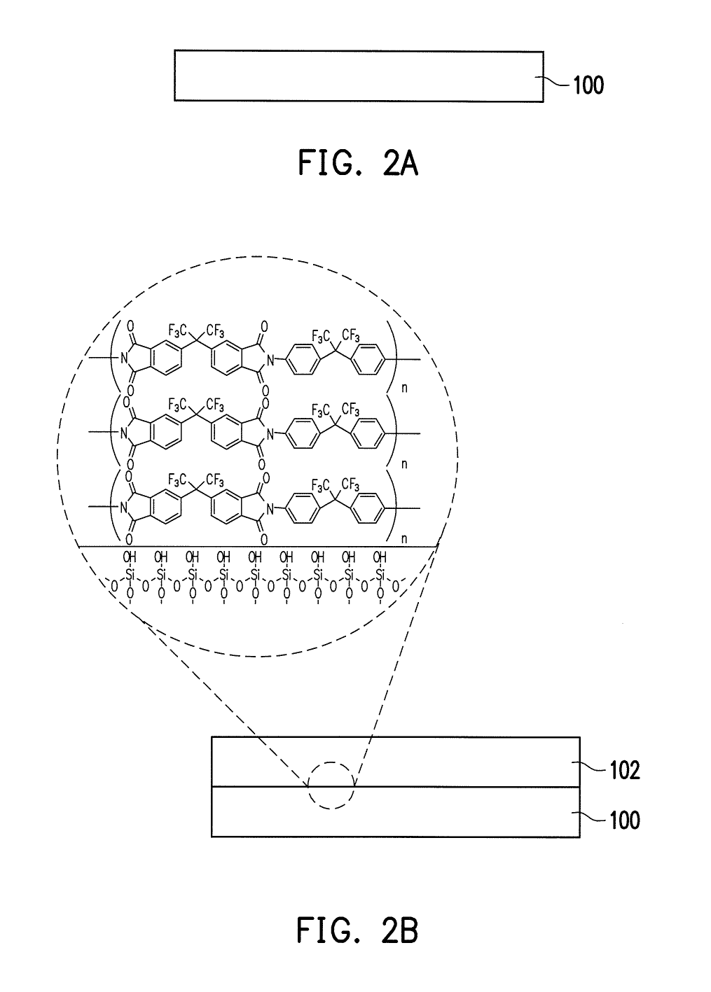

With reference to FIG. 2A to FIG. 2E, a detailed description of the method of manufacturing the flexible display panel is provided hereinafter.

FIG. 2A to FIG. 2E are schematic cross-sectional diagrams illustrating a method of fabricating a flexible display panel according to an embodiment of the invention. As shown in FIG. 1 and FIG. 2A, in step S1000, a rigid substrate 100 is provided. The rigid substrate 100 provided in the present embodiment includes a glass substrate.

In FIG. 1 and FIG. 2B, a fluorinated polyimide substrate 102 is formed on the rigid substrate 100 (step S1200). According to the present embodiment, the fluorinated polyimide substrate 102 is in direct contact with the rigid substrate 100.

Besides, the method of forming the fluorinated polyimide substrate 102 on the rigid substrate 100 is not specifically limited according to the present embodiment of the invention. For instance, the method of forming the fluorinated polyimide substrate 102 may include forming a fluorinated polyimide layer on the rigid substrate 100 by polymerizing a fluorinated monomer. Specifically, a fluorinated diamine compound and a fluorinated dianhydride compound dissolved in an organic solvent are polymerized to generate fluorinated polyamic acid; the resultant fluorinated polyamic acid is coated onto the rigid substrate 100; and in a high-temperature environment (300° C.-400° C.), the fluorinated polyamic acid is dehydrated and cyclized. The following reaction formula I is applied to elaborate the aforesaid method.

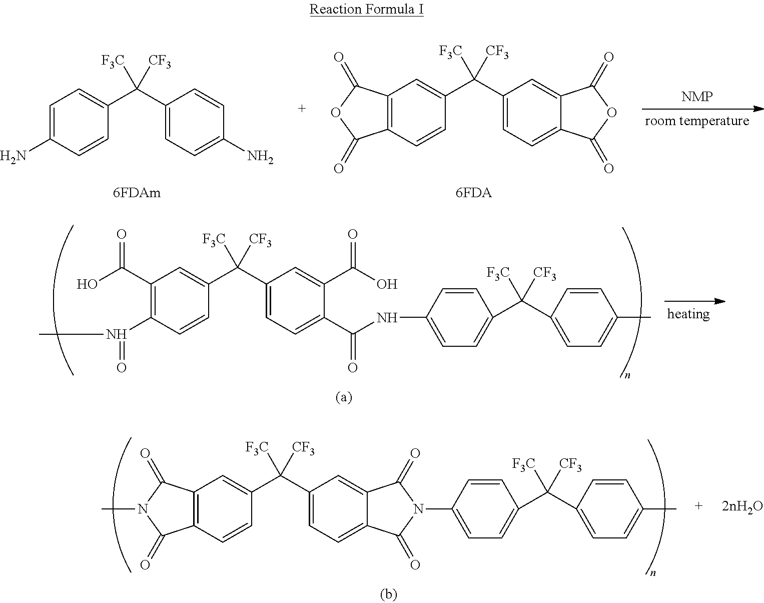

In an embodiment of the invention, at the room temperature (25° C.-30° C.), 10 mmol of 4,4-hexafluoroisopropylidene dianiline (6FDAm) is added to 20 ml of N-methyl pyrrolidinone (NMP) solvent, and the mixture is stirred until 6FDAm is completely dissolved. After 6FDAm is completely dissolved, 4,4-(hexafluoro-isopropylidene) diphthalic anhydride (6FDA) having the same number of moles is added to the mixture, and the resultant mixture is stirred for 48 hours to generate fluorinated polyamic acid (a). The fluorinated polyamic acid (a) is then coated onto the rigid substrate 100. In a nitrogen environment, the ambient temperature is raised to 350° C., and the heating time is 90 minutes. During the heating process, the NMP solvent is removed on the conditions of such temperature. The temperature is kept at 350° C. for 30 minutes, such that the fluorinated polyamic acid (a) is dehydrated and cyclized to form fluorinated polyimide (b). The temperature is naturally lowered down to the room temperature (25° C.-30° C.), so as to form the fluorinated polyimide substrate 102.

As shown in the reaction formula I, the fluorinated polyamic acid (a) and the fluorinated polyimide (b) are respectively represented by n fluorinated amic acid repeat units and n fluorinated imide repeat units.

Besides, in the previous embodiment, the fluorinated diamine compound is 6FDAm, and the fluorinated dianhydride compound is 6FDA, for instance. However, the type of the fluorinated diamine compound and the type of the fluorinated dianhydride compound are not specifically limited herein. In another embodiment of the invention, the fluorinated diamine compound may be bis(perfluorophenyl) alkane diamine, bis(perfluorophenyl) sulfone diamine, bis(perfluorophenyl) ether diamine, or a,a′-bis(perfluorophenyl) diisopropylbenzene diamine; and the fluorinated dianhydride compound may also be fluorobenzene dianhydride or the like. Specifically, the fluorinated diamine compound may be selected from the group consisting of the following compounds:

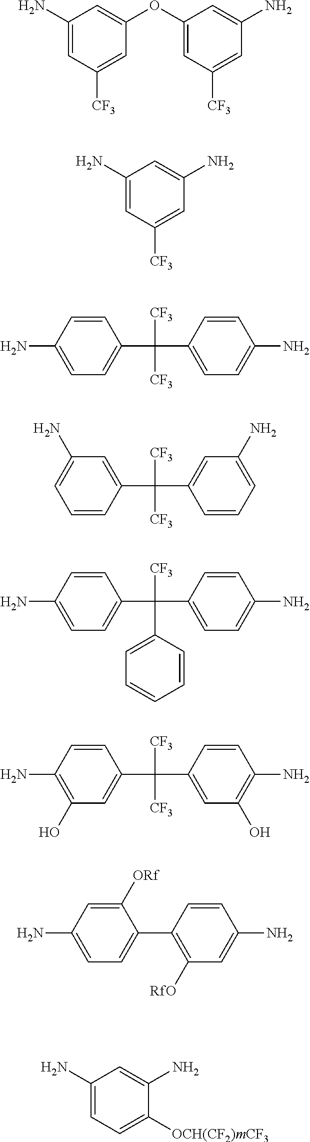

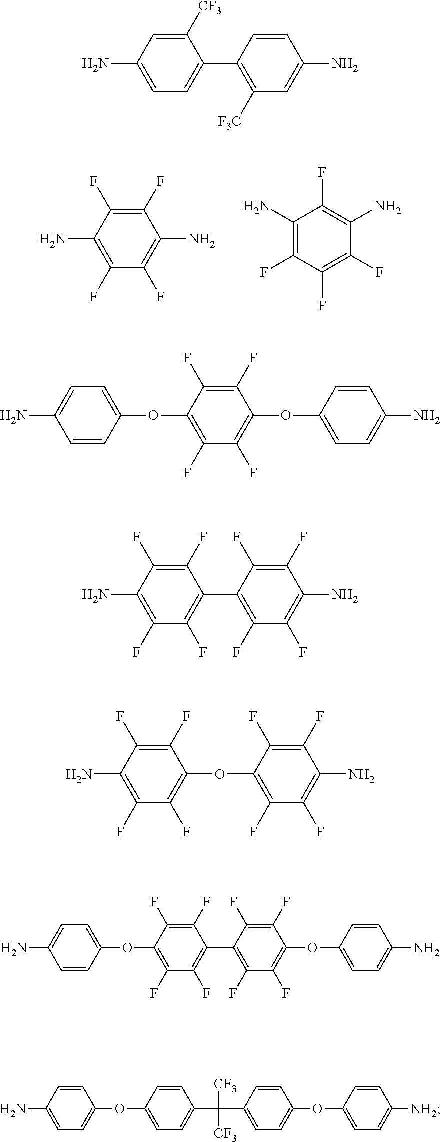

and the fluorinated dianhydride compound may be selected from the group consisting of the following compounds:

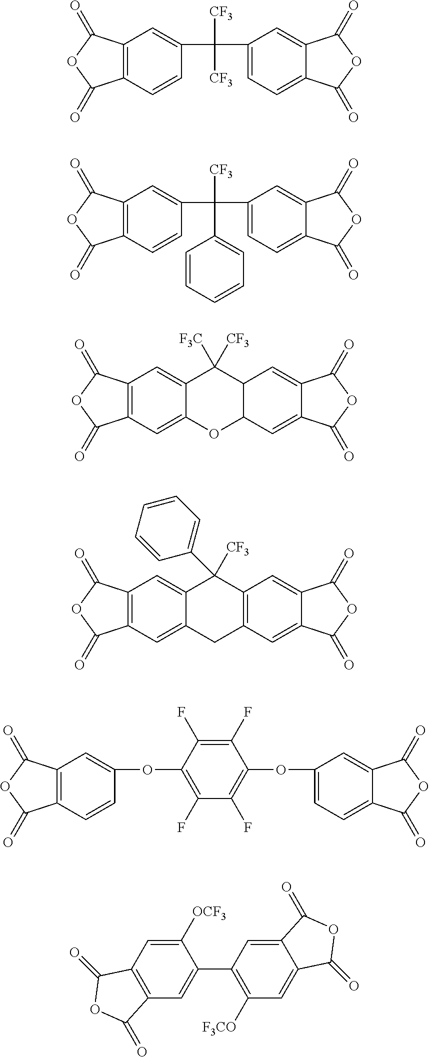

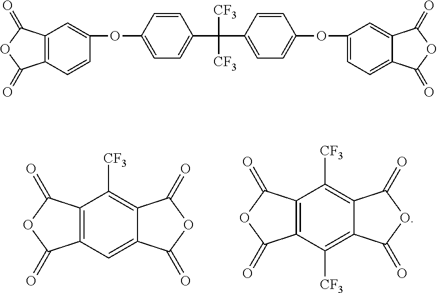 [SMILES: O=C1OC(=O)c2cc(Oc3ccc(C(c4ccc(Oc5ccc6c(c5)C(=O)OC6=O)cc4)(C(F)(F)F)C(F)(F)F)cc3)ccc21 ; O=c1oc(=O)c2c(C(F)(F)F)c3c(=O)oc(=O)c3cc12 ; O=c1oc(=O)c2c(C(F)(F)F)c3c(=O)oc(=O)c3c(C(F)(F)F)c12]

In the previous embodiment, the fluorinated polyamic acid (a) is coated onto the rigid substrate 100 and is then dehydrated and cyclized for forming the fluorinated polyimide substrate 102; however, the invention is not limited thereto. In another embodiment of the invention, the fluorinated polyimide substrate 102 may be foimed by dehydrating and cyclizing the fluorinated polyamic acid (a) and then coating the rigid substrate 100 with the resultant fluorinated polyimide (b) generated at the room temperature.

Besides, according to the present embodiment, the amount of fluorine in the fluorinated polyimide substrate 102 is from 5 wt % to 35 wt %. Here, the “amount of fluorine in the fluorinated polyimide substrate 102” is defined as the atomic mass of fluorine x the number of fluorinated imide repeat units/the total molecular mass of fluorinated polyimide. Particularly, according to the aforesaid method of forming the fluorinated polyimide substrate 102 by polymerizing a fluorinated monomer, a different kind of fluorinated monomer may be applied to form the fluorinated polyimide substrate 102 with different amounts of fluorine. For instance, according to the previous embodiment wherein 6FDAm and 6FDA respectively serve as the fluorinated diamine compound and the fluorinated dianhydride compound, the amounts of fluorine in the fluorinated polyimide substrate 102 is 35.2 wt %. As a matter of fact, the method of forming the fluorinated polyimide substrate 102 with different amounts of fluorine is not specifically limited herein.

In step S1200, because the fluorinated polyimides approach to each other at the room temperature (25° C.-30° C.), the repulsion and compression of CF₃ groups of adjacent fluorinated polyimides may force all of the CF₃ groups to be arranged along the same direction, as shown in FIG. 2B. Based on the above, the rigid substrate 100 described herein is a glass substrate, and the atoms in the rigid substrate 100 are neatly arranged; hence, the difference in the polarities of the fluorinated polyimide substrate 102 and the rigid substrate 100 leads to the reduction of the adhesion between the fluorinated polyimide substrate 102 and the rigid substrate 100. Here, the polarity of the fluorinated polyimide substrate 102 is higher than that of the rigid substrate 100.

According to the present embodiment, at the room temperature (25° C.-30° C.), the peeling force between the fluorinated polyimide substrate 102 and the rigid substrate 100 is 3 gf to 12 gf. Particularly, if the peeling force between the fluorinated polyimide substrate 102 and the rigid substrate 100 is less than 3 gf (i.e., the amount of fluorine is greater than 30 wt %), the fluorinated polyimide substrate 102 may easily fall off from the rigid substrate 100 during the glass-transport stage or may encounter the air bubble issue or the issue of warping in the latter steps of forming the display device (which will be described hereinafter); and if the peeling force between the fluorinated polyimide substrate 102 and the rigid substrate 100 is greater than 12 gf (i.e., the amount of fluorine is less than 5 wt %), it is rather difficult to separate the fluorinated polyimide substrate 102 from the rigid substrate 100, which may cause damages to the display device on the fluorinated polyimide substrate 102.

With reference to FIG. 1 and FIG. 2C, a display device 104 is formed on the fluorinated polyimide substrate 102 (step S1400). In step S1400, the manufacturing temperature of the display device 104 is 200° C.-450° C. Here, the display device 104 includes a liquid crystal display (LCD) device, an electrowetting display device, or an organic light emitting diode (OLED) display device. For instance, if the display device 104 is the OLED display device, the method of forming the display device 104 on the fluorinated polyimide substrate 102 includes forming an active device array layer on the fluorinated polyimide substrate 102 and forming an OLED layer on the active device array layer. In an embodiment of the invention, the manufacturing temperature of the active device array layer is about 200° C.-450° C., and the manufacturing temperature of the OLED layer is approximately 200° C.-350° C. Since the method of fowling the display device 104 is well known to people having ordinary skill in the pertinent art, no further descriptions are provided hereinafter.

In step S1400, the peeling force between the fluorinated polyimide substrate 102 and the rigid substrate 100 is 50 gf to 500 gf. That is, compared to the room temperature (25° C.-30° C.), if the ambient temperature is 200° C.-450° C., the peeling force between the fluorinated polyimide substrate 102 and the rigid substrate 100 drastically increases. Specifically, in such a high-temperature environment, the distance between the fluorinated polyimides increases, and the steric hindrance between the CF₃ groups of the adjacent fluorinated polyimides is lessened, and therefore the two CF₃ groups on one carbon atom may repel each other to arrange in opposite aligned positions, as shown in the following formula 1. Thereby, during the high-temperature manufacturing process of forming the display device 104, the polarity of the fluorinated polyimide substrate 102 will come close to the polarity of the rigid substrate 100 (the glass substrate), such that the adhesion between the fluorinated polyimide substrate 102 and the rigid substrate 100 is strengthened, i.e., the peeling force therebetween increases. Further, because the adhesion between the fluorinated polyimide substrate 102 and the rigid substrate 100 is strengthened during the high-temperature manufacturing process, in the process of manufacturing the display device 104 or in the glass-transport stage, the fluorinated polyimide substrate 102 is not easily peeled off from the rigid substrate 100, nor do the issue of air bubbles and the issue of warping occur between the fluorinated polyimide substrate 102 and the rigid substrate 100.

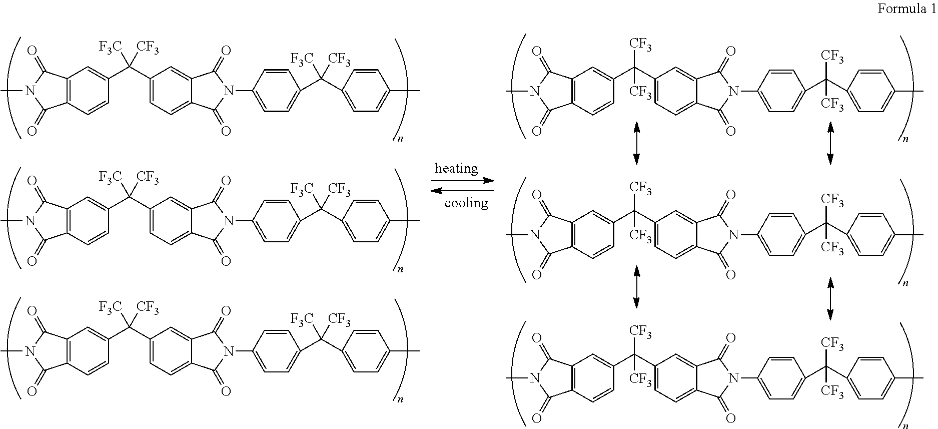

With reference to FIG. 1 and FIG. 2D, the fluorinated polyimide substrate 102 is separated from the rigid substrate 100 (step S1600). In step S1600, the manufacturing temperature is 25° C.-30° C. Here, the temperature range from 25° C. to 30° C. is defined as the room temperature. Specifically, after the display device 104 is formed in the high-temperature environment, the temperature is naturally reduced to the room temperature, and the step S1600 is them performed.

Besides, in step S1600, the peeling force between the fluorinated polyimide substrate 102 and the rigid substrate 100 is 3 gf to 12 gf. That is, if the ambient temperature is raised from the room temperature to about 200° C. -450° C., the peeling force between the fluorinated polyimide substrate 102 and the rigid substrate 100 is drastically increased. Once the temperature is again lowered down to the room temperature, the peeling force between the fluorinated polyimide substrate 102 and the rigid substrate 100 would return to the same peeling force as the initial peeling force while the fluorinated polyimide substrate 102 is initially foiined. Specifically, as described above, the drastically increased peeling force between the fluorinated polyimide substrate 102 and the rigid substrate 100 is attributed to the physical changes of the structure of the fluorinated polyimide in a high-temperature environment; therefore, in case of no chemical changes, the structure of the fluorinated polyimide returns to its original stage if the temperature is reduced to the room temperature, i.e., all of the CF₃ groups on the fluorinated polyimides are arranged toward the same direction, as shown in the formula 1. Thereby, in step S1600, the weakened adhesion between the fluorinated polyimide substrate 102 and the rigid substrate 100 allows the fluorinated polyimide substrate 102 to be easily separated from the rigid substrate 100 by an external force. As such, damages caused by the great adhesion between the fluorinated polyimide substrate 102 and the rigid substrate 100 to the display device 104 on the fluorinated polyimide substrate 102 can be prevented. In the present embodiment, a method of separating the fluorinated polyimide substrate 102 from the rigid substrate 100 includes mechanical debonding, laser lift-off, and temporary adhesion debonding.

With reference to FIG. 1 and FIG. 2E, a back plate 106 is adhered to the fluorinated polyimide substrate 102 (step S1800), so as to form the flexible display panel 10. According to the present embodiment, the back plate 106 and the display device 104 are respectively located on two opposite surfaces S1 and S2 of the fluorinated polyimide substrate 102. The back plate 106 is made of plastic, such as polyethylene terephthalate (PET), polycarbonate, and so forth, for instance.

I_{n a}ddition, step S1800 is optional. That is, in another embodiment of the invention, the fluorinated polyimide substrate may not be adhered to the back plate according to the type of the fluorinated polyimide substrate or the actual requirements for the flexible display panel.

(Experiments)

The properties of the peeling force between the fluorinated polyimide substrate and the rigid substrate may be further elaborated hereinafter with reference to experiments 1 and 2. Although the following experiments 1 and 2 are conducted, the materials, the amount of the materials, the proportion of the materials, the processing details, and the processing steps may be properly adjusted without departing from the scope of protection provided herein. Hence, the following experiments 1 and 2 may not serve to restrict the protection scope of the invention.

<Experiment 1>

The correlation between the amount of fluorine and the peeling force between the rigid substrate and the fluorinated polyimide substrate is elaborated by forming the fluorinated polyimide substrate with different amounts of fluorine on the glass substrate (i.e. the rigid substrate). The detailed description of the experiment 1 is given below.

At the room temperature, 10 mmol of 4,4-hexafluoroisopropylidene dianiline (6FDAm) is added to 20 ml of NMP solvent, and the mixture is stirred until 6FDAm is completely dissolved. After 6FDAm is completely dissolved, 4,4-(hexafluoro-isopropylidene) diphthalic anhydride (6FDA) having the same number of moles is added to the mixture, and the resultant mixture is stirred for 48 hours to generate fluorinated polyamic acid. The fluorinated polyamic acid is coated onto the glass substrate; after that, in a nitrogen environment, the ambient temperature is raised to 350° C., and the heating time is 90 minutes. Thereafter, the temperature is kept at 350° C. for 30 minutes, such that the NMP solvent is removed, and the fluorinated polyamic acid is dehydrated and cyclized to form the fluorinated polyimide substrate. After the temperature is reduced to the room temperature, an analysis instrument (e.g., a Fourier transformation infrared (FTIR) spectrum, an energy dispersive x-ray (EDX) analysis instrument, and so on) is applied to conduct element analysis, so as to obtain the amount of fluorine (approximately 35.2 wt %) in the resultant fluorinated polyimide substrate.

Through a bonding rearrangement mechanism in the high temperature, fluorinated polyimide with 35.2 wt % of fluorine is heated at 400° C. for different heating time, so as to form fluorinated polyimide substrates respectively having different amounts of fluorine, i.e., 28.1 wt %, 17.8 wt %, 7.95 wt %, and 0.3 wt %.

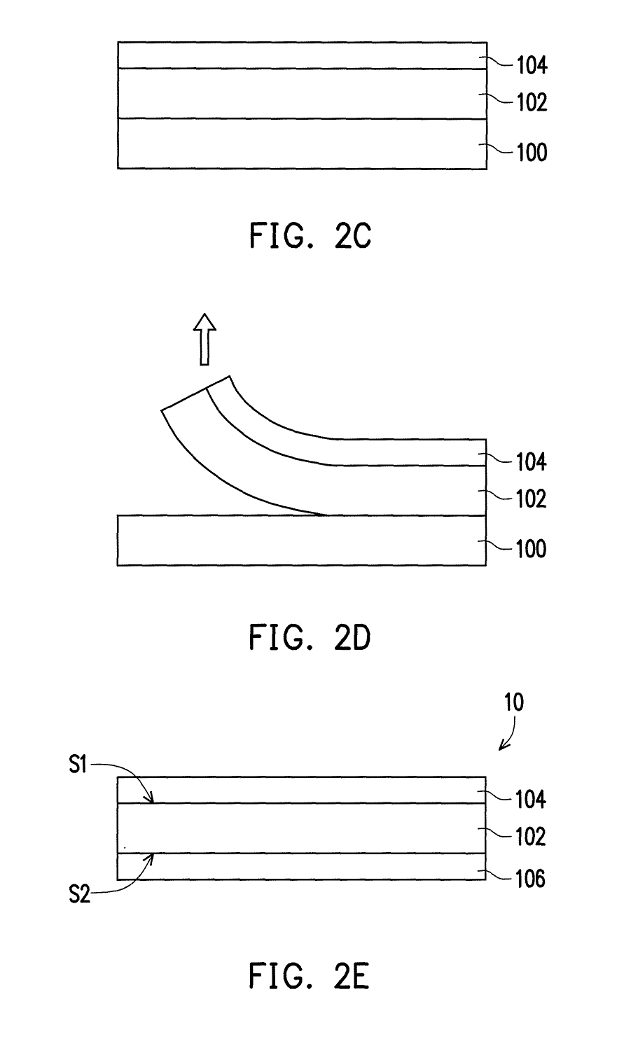

At the room temperature, a Shimadzu Ez-test-500N is employed to measure the peeling force between said five fluorinated polyimide substrates with different amounts of fluorine and the rigid substrate in the ASTM 3330D manner. The detailed measurement results will be elaborated below with reference to FIG. 3.

FIG. 3 illustrates the correlation between a peeling force between a fluorinated polyimide substrate and a glass substrate and an amount of fluorine in the fluorinated polyimide substrate. It can be learned from FIG. 3 that the amount of fluorine is in inverse proportion to the peeling force, i.e., the greater the amount of fluorine, the less the peeling force.

<Experiment 2>

The correlation between temperature and the peeling force between the glass substrate (i.e. the rigid substrate) and the fluorinated polyimide substrate is elaborated by heating the ambient environment form the room temperature to different temperatures. The detailed description of the experiment 2 is given below.

At the room temperature, 10 mmol of 4,4′-oxydianiline (ODA) is added to 20 ml of NMP solvent, and the mixture is stirred until ODA is completely dissolved. After ODA is completely dissolved, 6FDA having the same number of moles is added to the mixture, and the resultant mixture is stirred for 48 hours to generate fluorinated polyamic acid. The fluorinated polyamic acid is coated onto the glass substrate; after that, in a nitrogen environment, the ambient temperature is raised to 350° C., and the heating time is 90 minutes. Thereafter, the temperature is kept at 350° C. for 30 minutes, such that the NMP solvent is removed, and the fluorinated polyamic acid is dehydrated and cyclized to form the fluorinated polyimide substrate. An analysis instrument (e.g., a Fourier transformation infrared (FTIR) spectrum, an energy dispersive x-ray (EDX) analysis instrument, and so on) is applied to conduct element analysis, so as to obtain the amount of fluorine (approximately 18.7 wt %) in the resultant fluorinated polyimide.

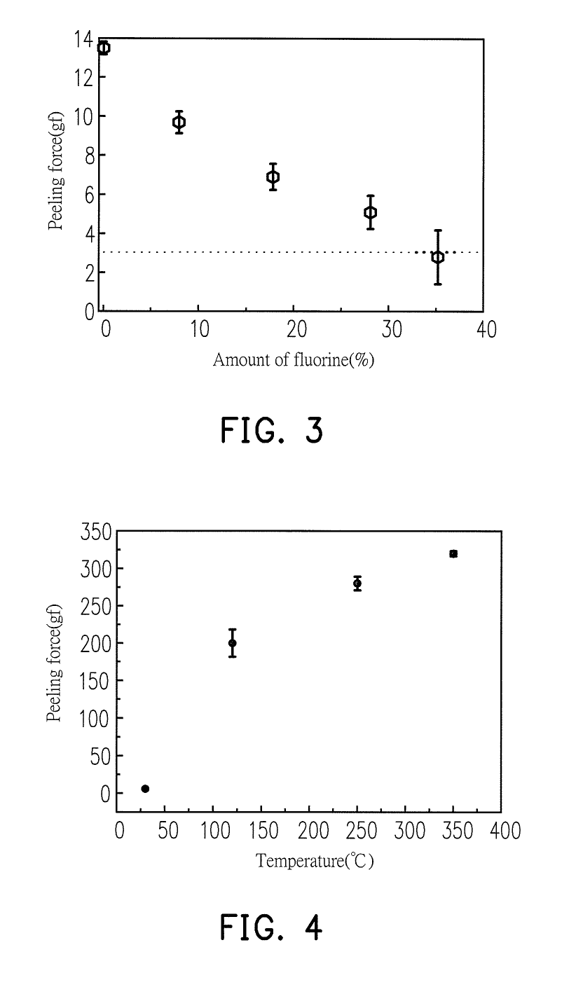

A hot ₚlate is employed to raise the ambient temperature from the room temperature to 120° C., 250° C., and 350° C., respectively, and the Shimadzu Ez-test-500N is employed to measure the peeling force between the fluorinated polyimide substrate and the rigid substrate in the ASTM 3330D manner. The detailed measurement results will be elaborated below with reference to FIG. 4.

FIG. 4 illustrates the correlation between temperature and a peeling force between a fluorinated polyimide substrate and a glass substrate. It can be learned from FIG. 4 that the peeling force between the fluorinated polyimide substrate and the glass substrate is about 6 gf at the room temperature; the peeling force between the fluorinated polyimide substrate and the glass substrate is about 200 gf at 120° C.; the peeling force between the fluorinated polyimide substrate and the glass substrate is about 280 gf at 250° C.; and the peeling force between the fluorinated polyimide substrate and the glass substrate is about 310 gf at 350° C. It can thus be concluded that the adhesion between the fluorinated polyimide substrate and the glass substrate at the room temperature is weak, and the adhesion between the fluorinated polyimide substrate and the glass substrate at any temperature greater than the room temperature is strengthened.

To sum up, according to the method of fabricating the flexible display panel provided herein, the fluorinated polyimide substrate with the amount of fluorine from 5 wt % to 30 wt % is directly formed on the rigid substrate, so as to manufacture the flexible display panel without forming any releasing layer. Besides, if the ambient temperature is 200° C.-450° C., the peeling force between the fluorinated polyimide substrate and the rigid substrate is 50 gf-500 gf; thereby, in the process of manufacturing the display device or in the glass-transport stage, the fluorinated polyimide substrate is not peeled off from the rigid substrate, nor do the issue of air bubbles and the issue of warping occur between the fluorinated polyimide substrate and the rigid substrate. Moreover, while the fluorinated polyimide substrate is separated from the rigid substrate, the peeling force between the fluorinated polyimide substrate and the rigid substrate is 3 gf-12 gf; thereby, the fluorinated polyimide substrate can be easily separated from the rigid substrate. As a result, damages caused by the great adhesion between the fluorinated polyimide substrate and the rigid substrate to the display device on the fluorinated polyimide substrate can be prevented.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. A method of fabricating a flexible display panel, comprising:
providing a rigid substrate;
forming a fluorinated polyimide substrate on the rigid substrate;
forming a display device on the fluorinated polyimide substrate; and
separating the fluorinated polyimide substrate from the rigid substrate.

2. The method according to claim 1, wherein when the display device is formed on the fluorinated polyimide substrate, a manufacturing temperature is from 200° C. to 450° C., and a peeling force between the fluorinated polyimide substrate and the rigid substrate is 50 gf to 500 gf.

3. The method according to claim 1, wherein when the fluorinated polyimide substrate is separated from the rigid substrate, a manufacturing temperature is from 25° C. to 30° C., and a peeling force between the fluorinated polyimide substrate and the rigid substrate is 3 gf to 12 gf.

4. The method according to claim 1, wherein a method of separating the fluorinated polyimide substrate from the rigid substrate comprises mechanical debonding, laser lift-off, and temporary adhesion debonding.

5. The method according to claim 1, wherein after the fluorinated polyimide substrate is separated from the rigid substrate, the method further comprises adhering a back plate onto the fluorinated polyimide substrate, and the back plate and the display device are respectively located on two opposite surfaces of the fluorinated polyimide substrate.

6. The method according to claim 1, wherein the rigid substrate comprises a glass substrate.

7. The method according to claim 1, wherein an amount of fluorine in the fluorinated polyimide substrate is from 5 wt % to 35 wt %.

8. The method according to claim 1, wherein the display device comprises a liquid crystal display device, an electrowetting display device, or an organic light emitting diode display device.

9. The method according to claim 1, wherein when the fluorinated polyimide substrate is formed on the rigid substrate, the fluorinated polyimide substrate is in direct contact with the rigid substrate.
